(19) United States
(12) Patent Application Publication
(10) Pub. No.: US 2011/0193753 A1
(43) Pub. Date: Aug. 11, 2011

(54) ANTENNA DEVICE AND PORTABLE TERMINAL HAVING THE SAME

(75) Inventors: Woon-Chun KIM, Suwon-si (KR); Won-Tae Choi, Hwasung-si (KR); Byung-Hoon Kim, Suwon-si (KR); Jung-Ho Yoon, Anyang-si (KR); Gyu-Won Kim, Suwon-si (KR)

(73) Assignee: SAMSUNG ELECTRO-MECHANICS CO., LTD.

(21) Appl. No.: 12/878,505

(22) Filed: Sep. 9, 2010

(30) Foreign Application Priority Data
Feb. 8, 2010 (KR) 10-2010-0011574

(51) Int. Cl. H01Q 1/24

(52) U.S. Cl. 343/702

(57) ABSTRACT

An antenna device and a portable terminal having the antenna device are disclosed. As an antenna device installed in a portable terminal in which a solar cell module or a display module is installed, the antenna device in accordance with an embodiment of the present invention can include a case, which has a housing part formed therein, a transparent protective window, which covers the housing part and allows a ray of light to pass through, and an antenna pattern, which is formed on the transparent protective window.

### CROSS-REFERENCE TO RELATED APPLICATIONS

This application claims the benefit of Korean Patent Application No. 10-2010-0011574, filed with the Korean Intellectual Property Office on Feb. 8, 2010, the disclosure of which is incorporated herein by reference in its entirety.

### BACKGROUND

1. Technical Field

The present invention is related to an antenna device and a portable terminal having the antenna device.

2. Description of the Related Art

Portable terminals have recently become increasingly multifunctional.

Particularly, since there is a great demand for various functions of wireless portable terminals, the portable terminals need not only an antenna for long distance communication such as voice calls but also a high-performance short distance antenna used for, for example, radio-frequency identification (RFID) or non-contact charging. These antennas are typically built in the main body of the portable terminal for the sake of design and saving the space.

In order to implement a high-performance antenna, a high-temperature annealing process is required. However, since the case of the conventional portable terminal is made of synthetic resin, it is difficult to form a high-performance antenna, and thus it is difficult to build the high-performance antenna in the main body of the conventional portable terminal.

### SUMMARY

The present invention provides a high-performance antenna device that can be built in the main body of a portable terminal, and the portable terminal having the antenna device.

An aspect of the present invention provides an antenna device installed in a portable terminal in which a solar cell module or a display module is installed. The antenna device in accordance with an embodiment of the present invention can include a case, which has a housing part formed therein, a transparent protective window, which covers the housing part and allows a ray of light to pass through, and an antenna pattern, which is formed on the transparent protective window.

The antenna pattern can include a loop pattern, which is formed along fringe areas of the transparent protective window.

The antenna pattern can be formed on a surface of the transparent protective window that faces the housing part.

The antenna pattern can be formed inside the transparent protective window.

The transparent protective window can be made of a material including a heat-resistant material.

Another aspect of the present invention provides a portable terminal. The portable terminal in accordance with an embodiment of the present invention can include a main body, which has a housing part formed therein, a transparent protective window, which covers the housing part and allows a ray of light to pass through, and an antenna pattern, which is formed on the transparent protective window.

The portable terminal can further include a solar cell module, which is installed in the housing part.

The portable terminal can further include a display module, which is installed in the housing part.

The antenna pattern can be used as an antenna for a radio-frequency identification (RFID) device.

The antenna pattern can be used as an antenna for a non-contact charging device.

The antenna pattern can include a loop pattern, which is formed along fringe areas of the transparent protective window.

The antenna pattern can be formed on a surface of the transparent protective window that faces the housing part.

The antenna pattern can be formed inside the transparent protective window.

The transparent protective window can be made of a material including a heat-resistant material.

Additional aspects and advantages of the present invention will be set forth in part in the description which follows, and in part will be obvious from the description, or may be learned by practice of the invention.

### BRIEF DESCRIPTION OF THE DRAWINGS

FIGS. 1 and 2 illustrate an antenna device and a portable terminal having the antenna device in accordance with an embodiment of the present invention.

FIG. 3 is a cross-sectional view illustrating an antenna device and a portable terminal having the antenna device in accordance with another embodiment of the present invention.

FIG. 4 is a cross-sectional view illustrating an antenna device and a portable terminal having the antenna device in accordance with yet another embodiment of the present invention.

### DETAILED DESCRIPTION

The features and advantages of this invention will become apparent through the below drawings and description.

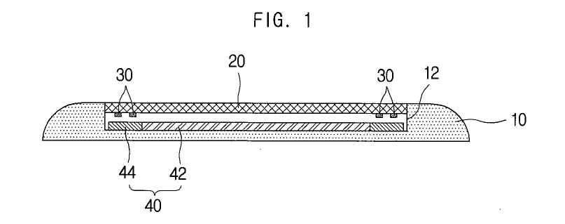

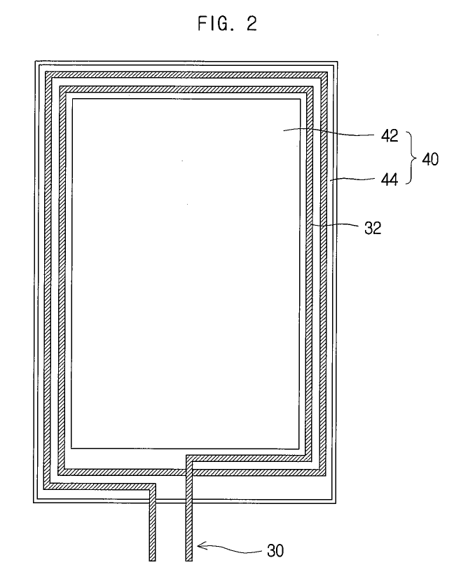

FIGS. 1 and 2 illustrate an antenna device and a portable terminal having the antenna device in accordance with an embodiment of the present invention.

The portable terminal of the present embodiment features that an antenna device is also embedded in a space where a solar cell module 40 or a display module (not shown) is installed and includes a main body 10, a transparent protective window 20 and an antenna pattern 30.

The main body 10 is where the main components of the portable terminal are disposed, and the main body 10 of the present embodiment has a housing part 12 that is opened on one surface thereof. Accordingly, the solar cell module 40 or the display module can be installed in the housing part 12 since an external beam can enter the housing part 12 or a beam generated from the inside of the housing part 12 can be emitted from the housing part 12.

In the present embodiment, as illustrated in FIG. 1, the housing part 12 is formed in a case that constitutes the main body 10, and the solar cell module 40, which generates electricity by using sunlight, is installed in the housing part 12.

The transparent protective window 20 allows a ray of light to enter the housing part 12 and covers the housing part 12. Accordingly, sunlight can reach the solar cell module 40, which is installed in the housing part 12, and an image that is generated by the display module installed in the housing part 12 can be viewed from the outside. Also, the solar cell module 40 and the display module, which are installed in the housing part 12, are protected from, for example, shocks or contamination.

Particularly, since the transparent protective window 20 of the present embodiment is made of a heat-resistant material, for example, reinforced glass, the antenna pattern 30, which will be described later, can be annealed at a high temperature. Specifically, since the heat-resistant transparent protective window 20 can withstand high temperatures, unlike a case made of synthetic resin, the antenna pattern 30, which is formed on the transparent protective window 20 by a method of, for example, printing, can be annealed at a high temperature. Accordingly, a precision and high-quality antenna pattern 30 can be formed on the transparent protective window 20.

The antenna pattern 30, which transmits and receives electric waves with another device for, for example, communication and power transmission, of the present embodiment can be annealed on the transparent protective window 20 at a high temperature, as described above. Accordingly, the antenna pattern 30 of the present embodiment can be formed precisely, thereby securing the quality of low resistance and high conductivity.

Therefore, a high-performance antenna device can be formed by using the antenna pattern 30 of the present embodiment. Specifically, the antenna pattern 30 of the present embodiment can be used as an antenna for a radio-frequency identification (RFID) device or non-contact charging device.

The radio-frequency identification device, which recognizes information wirelessly by using electric waves, requires an RFID tag and an RFID reader. The RFID tag, which is constituted by an antenna and an integrated circuit, writes information in the integrated circuit and transmits the information to the RFID reader through the antenna. Here, a high-performance antenna device is essential to improve the recognition rate and the transmission distance.

The portable terminal of the present embodiment can be equipped with the radio-frequency identification device, in which case the high-quality antenna pattern 30, which is formed on the transparent protective window 20, can be used as the antenna for the radio-frequency identification device.

The non-contact charging device charges an electronic device wirelessly when the electronic device is placed on a charging pad, and coil is wound where the charging takes place to form a magnetic field, which is used to let the electric current flow to the electronic device to be charged. Here, a high-performance antenna device to receive power is essential to increase the power transmission efficiency.

The portable terminal of the present embodiment can be equipped with the non-contact charging device, in which case the high-quality antenna pattern 30, which is formed on the transparent protective window 20, can be used as the antenna for the non-contact charging device.

Meanwhile, a minimal space can be used to accommodate the antenna since the antenna pattern 30 of the present embodiment is integrated into the transparent protective window 20.

Specifically, as illustrated in FIG. 2, the antenna pattern 30 of the present embodiment can include a loop pattern 32, which is formed along the fringe areas of the transparent protective window 20. An active area 42, in which the solar cell module 40 absorbs light or the display module emits light, is formed in the center area, and an inactive area 44 is formed around the periphery of the active area 42. Since the inactive area 44 does not absorb or emit light, the fringe areas of the transparent protective window 20 that cover the inactive area 44 do not need to transmit light.

Accordingly, in the present embodiment, the antenna pattern 30 is formed in the fringe areas of the transparent protective window 20 that correspond to the inactive area 44, in order to prevent the unnecessary waste (i.e., being unable to use an area where the light is blocked) of the active area 42 caused by the forming of the antenna pattern 30. Also, by forming the antenna pattern 30 in the shape of a loop, the antenna pattern 30 can have a sufficient length required for a desired performance.

Furthermore, as illustrated in FIG. 1, the antenna pattern 30 of the present embodiment can be formed on a surface of the transparent protective window 20 that faces the housing part 12, in order to prevent a damage caused by external shocks or contamination.

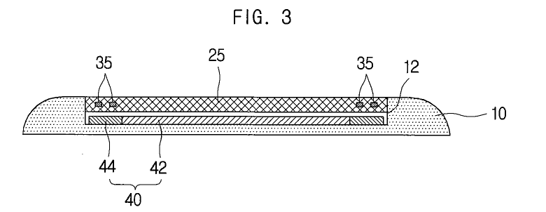

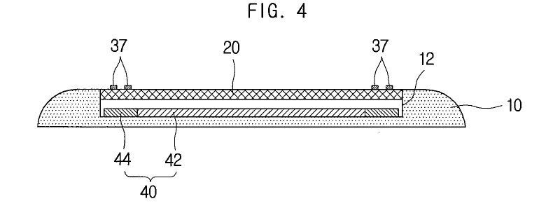

However, the disposition of the antenna pattern 30 is not restricted to this example, and an antenna pattern 35 can be formed inside the transparent protective window 20 (refer to FIG. 3) or an antenna pattern 37 can be formed on an outer surface of the transparent protective window 20 (refer to FIG. 4). Specifically, if the transparent protective window 20 has a stacking structure, the antenna pattern 30 can be built in between stacked members of the transparent protective window 20.

By utilizing certain embodiments of the present invention as set forth above, a high-performance antenna device can be built in the main body of a portable terminal by forming an antenna pattern on a transparent protective window, which covers a solar cell module or a display module that is built in the main body.

Also, by forming an antenna in the fringe areas of the transparent protective window, an unnecessary waste of space caused by the antenna being mounted can be minimized.

While the spirit of the invention has been described in detail with reference to certain embodiments, the embodiments are for illustrative purposes only and shall not limit the invention. It is to be appreciated that those skilled in the art can change or modify the embodiments without departing from the scope and spirit of the invention.

As such, many embodiments other than those set forth above can be found in the appended claims.

What is claimed is:

1. An antenna device installed in a portable terminal in which a solar cell module or a display module is installed, the antenna device comprising:
a case having a housing part formed therein;
a transparent protective window covering the housing part and allowing a ray of light to pass through; and
an antenna pattern formed on the transparent protective window.

2. The antenna device of claim 1, wherein the antenna pattern comprises a loop pattern formed along fringe areas of the transparent protective window.

3. The antenna device of claim 1, wherein the antenna pattern is formed on a surface of the transparent protective window that faces the housing part.

4. The antenna device of claim 1, wherein the antenna pattern is formed inside the transparent protective window.

5. The antenna device of claim 1, wherein the transparent protective window is made of a material comprising a heat-resistant material.

6. A portable terminal comprising:
a main body having a housing part formed therein;
a transparent protective window covering the housing part and allowing a ray of light to pass through; and
an antenna pattern formed on the transparent protective window.

7. The portable terminal of claim 6, further comprising a solar cell module installed in the housing part.

8. The portable terminal of claim 6, further comprising a display module installed in the housing part.

9. The portable terminal of claim 6, wherein the antenna pattern is used as an antenna for a radio-frequency identification (RFID) device.

10. The portable terminal of claim 6, wherein the antenna pattern is used as an antenna for a non-contact charging device.

11. The portable terminal of claim 6, wherein the antenna pattern comprises a loop pattern formed along fringe areas of the transparent protective window.

12. The portable terminal of claim 6, wherein the antenna pattern is formed on a surface of the transparent protective window that faces the housing part.

13. The portable terminal of claim 6, wherein the antenna pattern is formed inside the transparent protective window.

14. The portable terminal of claim 6, wherein the transparent protective window is made of a material comprising a heat-resistant material.
